(19) United States
(12) Patent Application Publication
(10) Pub. No.: US 2008/0269986 A1
(43) Pub. Date: Oct. 30, 2008

(54) System and Method for Controlling the Axle Load Split Ratio on a Vehicle With Two Front Axles

(75) Inventors: Hans Regnell, Ytterby (SE); Benny Liljeblad, Lerum (SE); Jens Gustafsson, Goteborg (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 12/089,187

(22) PCT Filed: Oct. 19, 2006
(86) PCT No.: PCT/SE2006/001188

§ 371 Date: Apr. 3, 2008

(30) Foreign Application Priority Data
Oct. 26, 2005 (SE) 0502375-0

(51) Int. Cl. B60G 17/018

(52) U.S. Cl. 701/37; 280/5.504

(57) ABSTRACT

A system is provided for controlling the load split between the axles and thereby the theoretical wheelbase of a vehicle having two front axles being suspended in suspension units at least some of which have springs with adjustable stiffness. A method for controlling the load split between the axles and to a motor vehicle including such a system and/or by use of such a method is also disclosed.

### BACKGROUND AND SUMMARY

The present invention relates to motor vehicles having two front axles and, more specifically, to controlling the distribution of axle loads and theoretical wheelbase of such vehicles. The invention relates to all types of motor vehicles including rigid trucks and tractors with and without trailers.

For vehicles with three or more axles, the theoretical wheelbase depends on the load split between the axles. For a truck with a single front axle and a rear bogie, the theoretical wheelbase will be the distance between the front axle and a position between the rear axles. If the load split between the rear axles is 50%, this position will be in the middle of the axles. Depending on the distribution of the goods loaded on the vehicle, the theoretical wheelbase will vary. The theoretical wheelbase will influences e.g. the turning radius of the vehicle, and it is therefore often necessary to find a compromise between the desired turning characteristics of the vehicle and the load split ratio between the axles in order to avoid overload of one or more of the axles.

There also exist vehicles with two or more front axles. These are mostly adapted for heavy loads and can be used for special trailer transports or on construction sites. There is normally a 50/50 load split between the front axles, with some deviations often depending on different frame inclinations. In most cases the steering geometry is calculated for a 50/50 load split or at least for a constant load split between the front axles.

By controlling the load split between the axles of a vehicle, the theoretical wheelbase can be altered. By doing this, it is possible to optimise the theoretical wheelbase for any given load situation. It may e.g. be necessary to have a small theoretical wheelbase and thereby a small turning radius under some driving conditions. However, minimisation of the theoretical wheelbase may result in load split ratios between the axles that lead to an overload condition for one or more axles. This may only be acceptable or desirable for short periods of time. On the other hand, optimisation of the load split ratio with respect to the loading of the axles may result in a larger turning radius that which is only acceptable under driving conditions where sharp turns can be avoided, such as when driving on motorways.

It is also possible to change the theoretical wheelbase in order to comply with legal requirements, e.g. different road load limits. These road limits may be temporary limits connected to season variations such as when the ground is thawing, or it may be limits for certain bridges. By altering the theoretical wheelbase, the vehicle can comply with these requirements.

It is desirable to provide a system and method for adjusting the theoretical wheelbase of a vehicle with two front axles to the actual driving conditions.

By making it possible to find the best compromise between the turning radius and axle loads for a given situation, the handling of the vehicle may be improved with a minimised risk for overloading one or more of the axles.

A variable theoretical wheelbase for vehicles with two front axles may also improve the efficiency of the transportation with respect to several aspects such as time, wear and fuel consumption. Furthermore, it may also make it easier to achieve legal axle loads for uneven load distributions. It is desirable to improve the transport and handling efficiency of a vehicle with respect to time, wear and fuel consumption.

It is desirable to improve the loading and unloading situation due to a larger degree of flexibility with respect to load distribution. The possibility of adjusting the load split ratio after the loading decreases or removes the need to avoid uneven load distribution. It is also possible to adjust the load split ratio during a loading or unloading situation.

It is desirable to improve the tipping stability of tipper vehicles and swap body vehicles.

The present invention relates in a first aspect to a system for controlling the load split ratio between the axles and thereby the theoretical wheelbase of a vehicle having two front axles being suspended in suspension units at least some of which have springs with adjustable stiffness, said system comprising load sensor means arranged to detect one or more load indication parameters from which the individual load on each of the axles can be determined, controller means receiving input from the load sensor means and determining settings for the stiffness of the springs, and means for adjusting the load split by setting the stiffness of the springs as determined by the controller means.

In the present description a number of technical terms are used, and these terms should normally be construed in a broad sense. For instance, “spring” is used in a broad sense and comprises coil springs, leaf springs, air bellows etc. “Stiffness” is used to describe the relationship between the forces acting on a spring and the resulting compression or extension of the spring. When a spring consists of an air bellow, the spring characteristic will typically be directly related to the air pressure in the bellow.

The theoretical wheelbase of a vehicle is typically calculated from the distance between the axles and the loads on each axle. It therefore depends on a number of parameters including the total load and the load distribution. The present invention is mainly related to but not limited to control of the theoretical wheelbase by varying the load split ratio between the axles; i.e. the ratios between the loads on the axles. The distance between the axles may be changed and/or the load manually redistributed on the vehicle. It will be possible to combine the possibilities provided by the present invention with one or more of these ways of varying the theoretical wheelbase.

In a preferred embodiment of the invention, the system comprises means for adjustment of the stiffness of two or more springs per axle suspension. The stiffness can preferably be adjusted individually for each spring. However, a system according to the present invention may also adjust all springs of a given axle suspension together. It may furthermore be possible to adjust some of the springs individually whereas others are to be adjusted together.

The springs may have linear spring characteristics, and the means for adjusting the load distribution may then comprise means for varying the spring constants of the springs. This may typically be applied to springs in the form of air bellows, where the spring constant may be varied by changing the air pressure. The springs may also have non-linear spring characteristics, or the characteristics may be linear in one region and non-linear in another region of their useable range of application. The springs may e.g. be coil springs having regions of different stiffnesses, and the overall stiffness of the spring may then be varied e.g. by pre-compression of one or more regions of the spring. The springs may also be leaf springs, and for this type of spring the stiffness may e.g. be adjusted by application of a bending moment. Another possibility may be to adjust the stiffness of a leaf spring by adjusting the effective length of the spring, i.e. the part of the spring that can take up forces from the load. The springs in a given vehicle may all be of the same type and/or have the same spring characteristics, or they may differ.

In one embodiment of the invention, the system may be used for vehicles wherein the axles are suspended in an air suspension system comprising springs in the form of air bellows, and the load sensor means may then detect the air pressure in the air bellows. The adjustments of the air pressure and thereby the stiffness of the springs may be carried out by use of an electronic air suspension control (ECS).

In another embodiment of the invention, the system may be used for vehicles wherein the springs are coil or leaf springs. The adjustments of the spring stiffness may then be carried out by compression means, such as mechanical devices used to vary the compression of the springs.

A desired theoretical wheelbase is obtained by adjusting the load split between the axles. However, for a given load distribution this is obtainable by a large number of combinations of spring constants. Some of these may be more advantageous than others. It may e.g. be preferable to keep the spring constants of the springs used for suspension units of a given axle as equal as possible, or it may be preferable to have different spring constants. These considerations are closely related to the actual design of the vehicle, and it may therefore be a part of the design or manufacturing process to take such considerations into account in the more detailed setting up of the control system.

The determination of the settings of the stiffness of the springs is preferably based on the actual driving conditions preferably being defined by selection of one among a number of predefined driving conditions each having a predetermined optimal theoretical wheelbase assigned. The theoretical wheelbase may be determined as close to the predetermined optimal value as possible while ensuring as even a load split between the axles as possible, and while furthermore ensuring that a predefined maximum allowable load is not exceeded for any of the axles. Such an even load split is normally referred to as a 50/50 load split. However, the theoretical wheelbase may also by determined as close to the assigned optimal value as possible while ensuring a predefined load split between the axles, and while furthermore ensuring that a maximum allowable load is not exceeded for any of the axles. A predefined load split different from 50/50 may e.g. be relevant for vehicles with different sizes of the axles, and the actual optimal load split will therefore depend on the actual vehicle.

Instead of or in addition to the selection between a number of predefined driving conditions, it may also be possible for the driver to select a desired theoretical wheelbase directly, i.e. without indirectly specifying it via the driving conditions. The theoretical wheelbase may have to be selected among a number of predefined values, or it may be possible to select any value within the possible range. This possible range will then depend e.g. on the actual layout of the vehicle. When it is possible to select the wheelbase directly, the best actual load split resulting in a theoretical wheelbase as close as possible to the selected one may still be determined by the system as described above.

In a preferred embodiment of the invention, the determination of the settings of the stiffness of the springs is based on the use of a database storing a list of interdependent values of load splits and theoretical wheelbases. Since the theoretical wheelbase is also dependent on the distances between the axles, this information must also be included in the determination. The distances between the axles may either be read automatically by sensors placed at appropriate positions on the vehicle, or they may have to be inputted by the operator of the system, this operator typically being the driver.

The controller means may further be adapted to receive and process input from an electronic brake system of the vehicle, said input adding temporary limitations to the transferable loads between the axles due to the present dynamic load conditions on each axle.

The system preferably automatically controls the suspension system in the described manner. However, the system may also indicate to the driver any need to adjust the suspension system, said indication preferably being communicated to the driver via a driver interface means provided with control means, preferably being manual control means, for effecting the necessary adjustment. Another possibility is that both options are possible and that the driver can switch between them e.g. by pressing a button and thereby activating the automatic control. The choice between automatic and manual control may e.g. depend on the actual driving conditions.

The system may further comprise one or more axle lifts that can be used for one or more of the front axles and/or one or more of the rear axles. When one or more axles are lifted, it may be necessary to redistribute the load split between the other axles. Whether or not each axle is lifted may be detected automatically by the load sensor means but the information may also have to be inputted by the driver. It may furthermore be possible to let the system automatically include possible lifts of one or more axles in the determination of the optimal theoretical wheelbase.

The present invention relates in a second aspect to a vehicle having a system as described above.

The present invention relates in a third aspect to a method for controlling the load split between the axles and thereby the theoretical wheelbase of a vehicle having two front axles being suspended in suspension units at least some of which have springs with adjustable stiffness, said method comprising the steps of detecting one or more load indication parameters from which the individual load on each of the axles can be determined, based on the load indication parameters determining settings for the stiffness of the springs, and adjusting the load split by setting the stiffness of the springs.

The load split may be adjusted by adjusting the stiffness of two or more springs per axle suspension. The stiffness may be adjusted individually for each spring or it may be adjusted for two or more springs together. The springs my have linear spring characteristics, and the load distribution may then be adjusted by varying the spring constant of the springs.

When the method is used in vehicles in which the axles are suspended in an air suspension system comprising springs in the form of air bellows, the air pressure in the air bellows may be detected by the load sensor means. The air pressure and thereby the stiffness of the springs may then be adjusted, e.g. by use of an electronic air suspension control (ECS).

When the method is used in vehicles in which the axles are suspended by means of coil or leaf springs, the spring stiffness may be adjusted e.g. by means of a mechanical device used to vary the compression of the springs.

In a preferred embodiment of the invention, the method may comprise determination of the settings of the stiffness of the springs based on the actual driving conditions being defined by selection of one among a number of predefined driving conditions each having a predetermined optimal theoretical wheelbase assigned. The theoretical wheelbase may be determined as close to the predetermined optimal value as possible while ensuring as even a load split between the axles as possible, and while furthermore ensuring that a predefined maximum allowable load is not exceeded for any of the axles. The theoretical wheelbase may alternatively be determined as close to the assigned optimal value as possible while ensuring a predefined load split between the axles, said load split being dependent on the actual vehicle, and while furthermore ensuring that a maximum allowable load is not exceeded for any of the axles. This later option may e.g. be used when the axles are not designed to carry the same load.

The method preferably comprises that the determination is based on the use of a database storing a list of interdependent values of load splits and theoretical wheelbases. The method may further comprise the steps of receiving and processing input from an electronic brake system of the vehicle, the input adding limitations, preferably temporary limitations, to the transferable loads between the axles due to the present dynamic load conditions on each axle.

In one embodiment of the invention the control of the suspension system in the described manner takes place automatically. In another embodiment the method comprises indicating to the driver any need to adjust the suspension system, said indicating being communicated to the driver via a driver interface means provided with manual control means for effecting the adjustment.

The present invention provides a large flexibility as to adjustment of the theoretical wheelbase when loading and unloading the vehicle due to the possibility of adjusting the load split afterwards. This advantage is even larger for vehicles that are partly loaded and/or unloaded at several points along a given route, since the present invention removes or minimises the need to repack the load.

The system can be even further deployed by using individual steering system for each front axle and hereby obtain an optimised steering geometry.

### BRIEF DESCRIPTION OF THE DRAWINGS

In the following, preferred embodiments of the present invention will be described with reference to the accompanying figures in which:

FIG. 1 is a schematic view of a vehicle having one front axle and two rear axles with a 50/50 load split between the rear axles.

FIG. 2 is a schematic view of a vehicle having two front axles with a 50/50 load split between them and two rear axles with a 50/50 load split between them.

FIG. 3 is a schematic view of a vehicle having two front axles with a 30/70 load split between them and two rear axles with a 70/30 load split between them.

FIG. 4 is a diagram illustrating a preferred embodiment of the invention.

### DETAILED DESCRIPTION

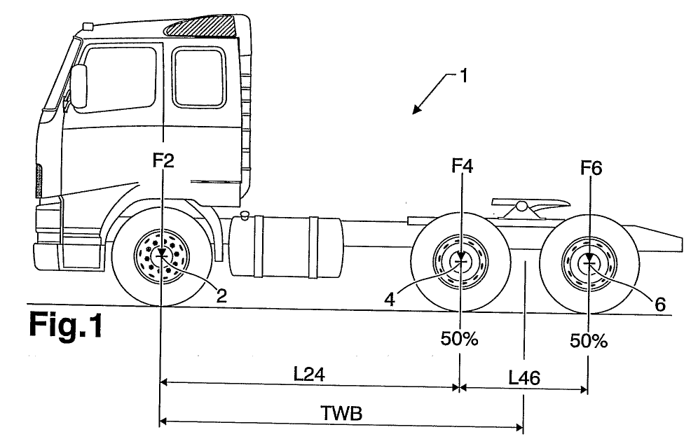

FIG. 1 illustrates a known vehicle with a theoretical wheelbase denoted TWB. The vehicle 1 is equipped with a front axle 2 and a bogie with two rear axles 4, 6. The theoretical wheelbase TWB is calculated depending on the load split between the axles. The general equation for the theoretical wheelbase, TWB, for such a vehicle is:

TWB=I₂₄+(F6*I₄₆)/(F4+F6)

where I24 and I46 are the distances between the first and second axles 2, 4 and the second and third axles 4, 6, respectively. F4 and F6 are the loads on the second and third axles 4, 6, respectively.

In FIG. 1 the load split between the rear axles 4, 6 is 50/50 which means that the theoretical wheelbase is the distance from the front axle 2 to midway between the rear axles 4, 6. This later point may be referred to as the theoretical rear axle centreline. By changing the load split ratio between the rear axles, the theoretical wheelbase can be altered. On a vehicle where the rearmost axle is a liftable, the theoretical wheelbase will with the axle lifted be the distance A between the front axle 2 and the second axle 4. This shorter theoretical wheelbase allows for a smaller turning radius and better driveability of the vehicle 1.

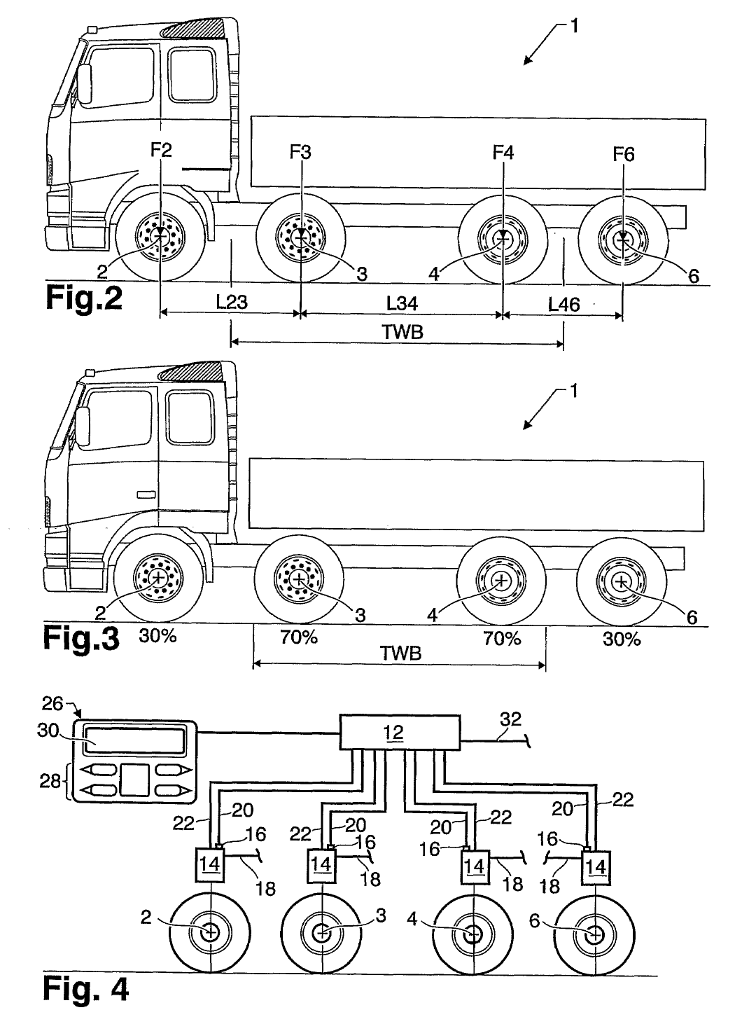

FIG. 2 illustrates a vehicle 1 equipped with two front axles 2, 3 and a bogie with two rear axles 4, 6. In this example, the load split ratio between the front axles 2, 3 is 50/50, and the load split ratio between the two rear axles 4, 6 is also 50/50. The theoretical wheelbase is denoted TWB and runs from a point in the middle of the front axles 2, 3 to a point in the middle of the rear axles 4, 6.

The theoretical wheelbase TWB is calculated depending on the load split between the axles.

The general equation for the theoretical wheelbase, TWB, for a vehicle with two front axles and two rear axles is:

TWB=(F2*I₂₃)/(F2+F3)+I₃₄+(F6*I₄₆)/(F4+F6)

where I₂₃ is the distance between the first and second axles 2, 3, I₃₄ is the distance between the second and third axles 3, 4, and 146 is the distance between the third and fourth axles 4, 6. F2, F3, F4, and F6 are the loads on the first, second, third and fourth axle, respectively.

In FIG. 3 the load split between the two front axles 2, 3 is 30/70, and the load split between the two rear axles 4, 6 is 70/30. This results in a smaller theoretical wheelbase, TWB, and thereby a smaller possible turning radius of the vehicle. On the other hand it also results in a larger load on two of the axles 3, 4 than for the 50/50 split. It is therefore advantageous to make sure that no axle is overloaded when the theoretical wheelbase is adjusted. This load split ratio, and thus this theoretical wheelbase, will improve the steering characteristics of the vehicle, which is advantageous when driving on e.g. a construction site. When driving on a highway, a longer theoretical wheelbase is preferred in order to improve the stability of the vehicle or vehicle combination.

By adjusting the load split ratio between the two front axles, the driving parameters of the vehicle can be adjusted. This can be used to optimise the traction of the vehicle or to optimise the steering behaviour of the vehicle. If the vehicle in FIG. 3 has axle 4 as the driven axle, the traction of the vehicle can be improved by changing the load split ratio. This is done by placing a higher load on axle 4. In this case, this can be achieved by altering the load split so that a higher load is placed on axle 2 and thus removing load from axle 3. Since this is related to traction, a short overload on axle 4 can be allowed. There are legal regulations relating to this, but in one situation, a specific overload is allowed when the vehicle is driven below 30 km/h. In another situation, a time interval is used. The specific overload can also be limited so that the vehicle is damaged by an excessive overload on one axle.

When the vehicle is loaded, the load split ratio can be used to optimise the steering characteristics of the vehicle. Depending on the position of the load on the vehicle, the vehicle can be either oversteered or understeered. This behaviour can change depending on the position of the load. When a fully loaded vehicle is partly unladen, the load split ratio can be used to adjust the steering behaviour so that the steering behaviour does not change for the vehicle, regardless of the position of the load. This also applies when the vehicle is towing a trailer. The stability for such a vehicle is improved with a longer theoretical wheelbase.

The load split ratio can also be used to improve the braking behaviour of the vehicle. By adjusting the load split ratio of the two front axles, it is possible to adapt the load on each axle in order to transfer an equal amount of brake torque to each axle. With a fixed load split ratio, most of the load when braking will fall on the front axle, especially when braking on a downhill slope with a fully laden vehicle. This can also be used to distribute the break torque on the rear axles in an equal or preferred manner.

FIG. 4 schematically illustrates an embodiment of an axle load control system according to the invention. The axle load control system is preferably integrated with a wheel suspension system with controller means 12, such as a suspension control processor. In a preferred embodiment, the wheel suspension system is an air suspension system comprising suspension units 14 in the form of air bellows, at least on the two rear axles 4, 6 but preferably on all axles. It should be noted that the invention is not limited to the use of such air bellows as suspension units 14, but that other types of suspension units like 5 coils springs, leaf springs or hydraulic oil-dampened cylinders (not shown) may also be used. Load sensor means 16 are arranged at each of the axles 2, 3, 4, 6 for detecting one or more load indication parameters. Each axle preferably has two or more load sensor means 16, but it is also possible to have only one load sensor means per axle. In a preferred embodiment comprising air bellows, the load sensor means are adapted to detect the air pressure in the air bellows. The load sensor means 16 provide these parameters to the suspension control processor 12, which translates the parameters into actual axle load values for the individual axles 2, 3, 4, 6. The suspension units 14 are supplied with pressurized air from an onboard source of compressed air (not shown) via pressurized air supply conduits 18. The load sensor means 16 are connected to the control processor 12 by means of sensor signal lines 20. Additionally, control signal lines 22 are arranged from the control processor 12 to each suspension unit 14.

When the vehicle is equipped with a coil or leaf spring suspension, the load sensor means 16 will detect the load on the axles depending on the type of sensor used. It is e.g. 20 possible to use a sensor that transforms the height information of the axle into a load value.

The control processor 12 may be arranged to compare the actual axle load values with a predefined maximum allowable axle load value for each axle. Then the control processor 12 controls—or indicates to a driver the need to control—the wheel suspension system so as to effect an individual adjustment of the suspension characteristics for each axle 2, 3, 4, 6. This is made in such a way that excess axle load on an overloaded axle is transferred to one or more of the remaining axles thereby adjusting the theoretical wheelbase of the vehicle. The term excess axle load here means the axle load which exceeds a maximum allowed axle load. The axle load control system thus enables an adjustment of the theoretical wheelbase of the vehicle without the risk of overloading an axle.

In a preferred embodiment of the invention, the control processor 12 is arranged to continuously compare the actual axle load values with said predefined maximum allowable 35 axle load value for each axle, and to automatically control the wheel suspension system in the described manner.

In an alternative embodiment of the invention, the control processor 12 is likewise arranged to continuously compare said actual axle load values with the predefined 40 maximum allowable axle load value for each axle. However, in this embodiment the axle load control system indicate the need to control the wheel suspension system in the described manner to a driver. This indication may suitably be communicated to the driver via a driver interface means 26 as shown in FIG. 5.

In one embodiment, the driver interface means 26 is preferably provided with manual control means 28, e.g. in the form of buttons, for choosing a mode of operation described by a driving condition to be chosen among a number of predefined driving conditions. These may e.g. be the following: “small turning radius necessary”, “small town”, “larger town”, “highway”, and “motorway”. The possible driving conditions are mentioned in order of decreasing necessary turning radius. Each driving condition has an optimal theoretical wheelbase assigned which depends on other parameters as well, such as the distance between the axles 2, 3, 4, 6. Actual values for these parameters must therefore either be read automatically by the system by means of appropriate sensors, or they may have to be entered into the system by the driver. The driver interface means 26 preferably also comprises a visual display 30 for providing information to the driver.

The suspension control processor 12 receives input from the load sensor means 16 and determines based thereon the actual loads on each axle 2, 3, 4, 6. The control system preferably comprises a database storing a list of interdependent values of load splits and theoretical wheelbases. A number of such load splits will typically result in the same theoretical wheelbase, and as a starting point the one closest to a predefined optimal load split is chosen. This optimal load split will for many vehicles be an even distribution of the load on the axles 2, 3, 4, 6. However, it may be any predefined load split which will e.g. depend on the actual allowable load on the axles, which axles may differ in size.

The optimal load splits corresponding to the optimal theoretical wheelbase for the selected driving condition is used together with the measured actual axle loads to control whether this optimal theoretical wheelbase is acceptable, i.e. whether the maximum allowable axle load is not exceeded for any of the axles. If that is the case, the suspension control processor 12 determines the adjustments of the spring stiffnesses resulting in this load split, and the spring stiffnesses are adjusted accordingly by means of the adjusting means. When the suspension system is air based, this adjustment will comprise changing the air pressure in one or more of the air bellows by means of the pressurized air supply conduits 18.

If the first chosen load splits together with the actual loads result in overloading one or more of the axles, a new—i.e. not optimal—value for the theoretical wheelbase is tried according to a predefined criteria. Such a criteria could e.g. be to change the optimal value by a given percentage, such as by 1 or 5 percent, depending on the actual vehicle. For the new value of the theoretical wheelbase it is checked whether an acceptable load split is obtainable. More precise information on how to carry out this iterative process in order to find the best compromise between the theoretical wheelbase and axle loads is preferably an integrated part of the control system. After a number of iterations, the system provides the driver with information about the result, and he has to confirm, e.g. by pressing an accept- or reject-button, whether the result is acceptable. Situations may arise in which he will have to reject the available possible adjustment, e.g. if he knows that the resulting turning ability of the vehicle is not acceptable for the actual situation. He may then either have to redistribute the load or choose another driving route.

In another embodiment, the driver interface means 26 is provided with manual control means 28, e.g. in the form of buttons, for choosing a specific theoretical wheelbase. This may be advantageous when e.g. approaching a bridge with a wheelbase restriction. In this way, it is possible for the driver to conform to the wheelbase requirement by adjusting the theoretical wheelbase of the vehicle. This new wheelbase setting may not provide the best driveability for the vehicle, but can be used when required. When the bridge is passed, the driver can revert to the previous wheelbase setting in an easy way.

In another embodiment of the invention (not shown) it may be possible for the driver to choose between a number of predefined load splits. In this case the manual control means may e.g. include buttons for the following load splits between the two front axles and or between the two rear axles: “60/40”, “80/20”, “RESET 50/50”, “40/60” and “80/20”. The driver interface means may also be provided with a visual display that can display warning messages such as “CAUTION! AXLE OVERLOAD”. The driver may then use the manual control means to choose an appropriate adjustment setting in order to relieve the overloaded axle.

A similar driver interface means (not shown) may be used also in the case where the individual adjustment is made automatically by the axle load control system of the invention. In such a case, the driver interface means may display the current adjustment setting for the driver. The driver interface means may also be integrated in a general suspension control display of the vehicle.

The suspension control processor 12 may further be adapted to receive and process input from an electronic brake system (EBS) of the vehicle. The electronic brake system is not shown in the diagram of FIG. 4, although an EBS-signal line 32 is schematically indicated in the figure leading to the control processor 12. The input from the electronic brake system may add temporary limitations to the transferable loads between axles due to present dynamic load conditions on each axle.

In an embodiment of the invention it is possible to detect the load on each wheel. These measures can either be used to first determine a load on each axle and then to proceed as described above. However, the load values for each wheel may also be used to take the load distribution along one or more of the axles into account whereby it may be possible to optimise the handling of the vehicle even further.

When the system described above is used for tipper vehicles and swap body vehicles, it may be possible to improve the tipping stability of the vehicle by incorporating the possibility of selecting an appropriate load split between the rear axles. This may be an additional feature in the system or it may be one of the “driving conditions” which the driver can choose between. The actual design of the vehicle and the variation in stability dependent on the position of the centre of gravity of the load will then have to be taken into account in the determination of the optimal load split. The load split may be set to a constant value during tipping or it may be varied stepwise or continuously. For a swap body vehicle, it is preferred to have a long theoretical wheelbase when loading and unloading. In this case, it would be preferred to have the entire load on the first axle 2 and the rearmost axle 6. Due to limitations for the allowed axle load, the system can transfer enough load to the other axles so that the axle load limitations are within limits, and at the same time optimise the loading conditions.

In another embodiment, the vehicle is equipped with two front axles and three rear axles (not shown). In this example, the load split ratio between the rear axles can be adjusted using all three axles. Together with the adjustment of the load split ratio between the front axles, the theoretical wheelbase can be adjusted to a great extent.

1. A system for controlling a suspension system load split between axles and, thereby, a theoretical wheelbase of a vehicle having two front axles suspended in suspension units at least some of which have springs with adjustable stiffness, the system comprising
load sensor means arranged to detect one or more load indication parameters from which an individual load on each of the axles can be determined,
controller means receiving input from the load sensor means and determining settings for stiffness of the springs and
means for adjusting the load split by setting the stiffness of the springs as determined by the controller means.

2. A system according to claim 1, wherein the system comprises means for adjustment of the stiffness of at least two springs per axle suspension.

3. A system according to claim 1, wherein the adjusting means is adapted to set stiffness individually for each spring.

4. A system according to claim 1, wherein the springs have linear spring characteristics, and wherein the means for adjusting the load distribution comprises means for varying spring constants of the springs.

5. A system according to claim 1, wherein the axles are suspended in an air suspension system comprising springs in the form of air bellows, and wherein the load sensor means detects the air pressure in the air bellows.

6. A system according to claim 5, wherein the adjusting means adjusts stiffness of the springs by adjusting air pressure and comprises an electronic air suspension control.

7. A system according to claim 1, where the springs are coil or leaf springs and wherein adjustments of spring stiffnesses are carried out by means of a mechanical device used to vary compression of the springs.

8. A system according to claim 1, wherein the determination of the settings of the stiffness of the springs is based on actual driving conditions defined by selection of one among a plurality of predefined driving conditions each having a predetermined optimal theoretical wheelbase assigned.

9. A system according to claim 8, wherein the theoretical wheelbase is determined as close to a predetermined optimal value as possible while ensuring as even a load split between the axles as possible, and while furthermore ensuring that a predefined maximum allowable load is not exceeded for any of the axles.

10. A system according to claim 8, wherein the theoretical wheelbase is determined as close to an assigned optimal value as possible while ensuring a predefined load split between the axles, and while furthermore ensuring that a maximum allowable load is not exceeded for any of the axles.

11. A system according to according to claim 1, wherein the determination is made by using a database storing a list of interdependent values of load splits and theoretical wheelbases.

12. A system according to claim 1, wherein the controller means are further adapted to receive and process input from an electronic brake system of the vehicle, the input adding temporary limitations to the transferable loads between the axles due to present dynamic load conditions on each axle.

13. A system according to claim 1, wherein the system automatically controls the suspension system.

14. A system according to claim 1, wherein the system indicates to the driver any need to adjust the suspension system, the indication being communicated to the driver via a driver interface means provided with control means for effecting the adjustment.

15. A system according to claim 1, further comprising at least one axle lift.

16. A system according to claim 15, wherein at the at least one axle lift is used for at least one of at least one of the front axles at least one of the rear axles.

17. A vehicle having a system according to claim 1.

18. A method for controlling a suspension system load split between axles and, thereby, a theoretical wheelbase of a vehicle having two front axles being suspended in suspension units at least some of which have springs with adjustable stiffness, the method comprising the steps of:
detecting at least one load indication parameter from which an individual load on each of the axles can be determined, and
determining settings for stiffness of the springs based the at least one load indication parameter, and
adjusting the load split by setting the stiffness of the springs.

19. A method according to claim 18, wherein the load split is adjusted by adjusting the stiffness of two or more springs per axle suspension.

20. A method according to claim 19, wherein the load split is adjusted by adjusting the stiffness individually for each spring.

21. A method according to claim 18, wherein the springs have linear spring characteristics, and wherein the load distribution is adjusted by varying spring constants of the springs.

22. A method according to claim 18, wherein the axles are suspended in an air suspension system comprising springs in a form of air bellows, and wherein air pressure in the air bellows is detected by the load sensor means.

23. A method according to claim 22, wherein the air pressure in the bellows and thereby the stiffness of the springs is adjusted by use of an electronic air suspension control.

24. A method according to claim 18, wherein the springs are coil or leaf springs and wherein spring stiffnesses are adjusted by means of a mechanical device used to vary compression of the springs,

25. A method according to claim 18, wherein the determination of the settings of the stiffness of the springs is based on actual driving conditions being defined by selection of one among a number of predefined driving conditions each having a predetermined optimal theoretical wheelbase assigned.

26. A method according to 25, wherein the theoretical wheelbase is determined as close to a predetermined optimal value as possible while ensuring as even a load split between the axles as possible, and while furthermore ensuring that a predefined maximum allowable load is not exceeded for any of the axles.

27. A method according to 25, wherein the theoretical wheelbase is determined as close to an assigned optimal value as possible while ensuring a predefined load split between the axles the load split being dependent on the vehicle, and while furthermore ensuring that a maximum allowable load is not exceeded for any of the axles.

28. A method according to according to claim 18, wherein the determination is based on the use of a database storing a list of interdependent values of load splits and theoretical wheelbases.

29. A method according to claim 18, further comprising steps of receiving and processing input from an electronic brake system of the vehicle, the input adding limitations to transferable loads between the axles due to present dynamic load conditions on each axle.

30. A method according to claim 18, wherein control of the suspension system takes place automatically.

31. A method according to claim 18, comprising indicating to a driver any need to adjust the suspension system, the indicating being communicated to the driver via a driver interface means provided with manual control means for effecting the adjustment.
